(19) United States
(12) Patent Application Publication
(10) Pub. No.: US 2005/0239452 A1
(43) Pub. Date: Oct. 27, 2005

(54) METHOD FOR MANAGING A MOBILE PHONE ACCORDING TO BROADCAST AREA CODE

(76) Inventor: Sumei LIN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,065

(22) Filed: Apr. 26, 2005

(30) Foreign Application Priority Data
Apr. 27, 2004 (TW) 093111796

(51) Int. Cl. H04M 3/42

(52) U.S. Cl. 455/425

(57) ABSTRACT

A method for managing a mobile phone according to a broadcast area code, which includes a mobile country code (MCC), performs filtration for an incoming call that can be determined according to an MCC corresponding to a phone number stored in a phone book. The mobile country code can be provided by a public land mobile network (PLMN).

### BACKGROUND OF INVENTION

1. Field of the Invention

The invention relates to method for managing a phone book of a mobile phone according to an area code, and more particularly, to a method of setting corresponding properties among phone numbers of a phone book of a mobile phone according to an area code of a wireless signal.

2. Description of the Prior Art

Currently, wireless mobile communication allows for a roaming function. That is, users of mobile phones can use the mobile communication services in other countries. Roaming services can be divided into “automatic roaming” and “non-automatic roaming”. Automatic roaming is utilized when the communication system is the same as that of the phone's home country (e.g. Taiwan), so the users can utilize the same phone number and the same mobile phone while visiting other countries (for example, in countries of Europe). Non-automatic roaming is utilized when the communication system is the different from that of the phone's home country, so the users have to change the phone number or the mobile phone itself in order to match the communication system of the visited country (for example, Japan or Korea).

Roaming services provide users with a lot of conveniences. However, a problem can commonly occur. For example, when a user visiting another country utilizes a phone number based in Taiwan and utilizes a roaming service, if someone calls the user from Taiwan, this person has to pay for the roaming service. At this time, if the user does not pick up the phone, and has a voice mail or call transfer set up, the call will be transferred back to Taiwan so that the caller can leave a message in the voice mail. The result is that the caller must pay for the roaming service even though the call was transferred to a system (e.g. voice mail) in the roaming user's home country (Taiwan). This can lead to many users being charged for services that they did not intend to use. Furthermore, if users only want to receive calls from specific people (such as parents or specific friends), the mobile phone cannot be turned off to solve this problem. Therefore, users have to set a calling limitation by themselves. That is, a user must check the phone numbers of the phone book of the mobile phone, and set calling limitations according their demand. Obviously, this wastes a lot of the user's time, is inconvenient, and reduces the utilization of roaming services.

### SUMMARY OF INVENTION

It is therefore one of primary objectives of the claimed invention to provide a method for managing a phone book of a mobile phone according to an area code of the wireless signal broadcast, to solve the above-mentioned problem.

According to an exemplary embodiment of the claimed invention, a method for managing a mobile phone is disclosed, where the mobile phone comprises a record code. The method comprises receiving an area code; comparing the area code and the record code; and if the area code is the same as the record code, the mobile phone processes a call in a first mode, and if the area code is different from the record code, the mobile phone processes the call in a second mode.

Furthermore, a mobile phone for communicating with a base station is disclosed, where the base station broadcasts an area code according to a location of the base station. The mobile phone stores a record code, and comprises a wireless communication module for receiving the area code; a memory module for storing the record code; and a processing module for controlling the mobile phone to process a call in a first mode when the area code is the same as the record code, and for controlling the mobile phone to process the call in a second mode when the area code is not the same as the record code.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a communication system according to the present invention.

FIG. 2 is a flowchart illustrating a telecom system service end informing a mobile phone of a call.

FIG. 3 is a diagram illustrating each phone number and corresponding MCC stored in a memory module of a mobile phone.

### DETAILED DESCRIPTION

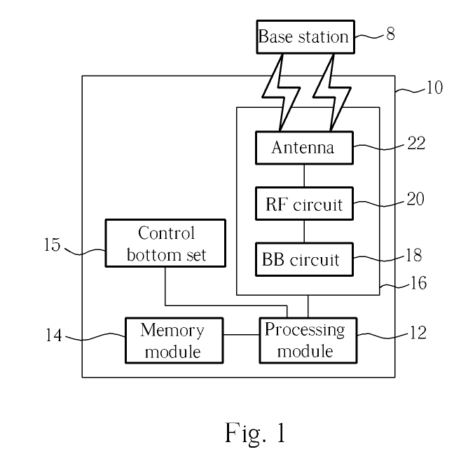

Please refer to FIG. 1, which is a diagram of a base station 8 and a mobile phone 10 according to the present invention. The mobile phone 10 is utilized to communicate with the base station 8. As shown in FIG. 1, the mobile phone 10 comprises a processing module 12 for controlling the operation of the mobile phone 10, a memory module 14 for storing data of the mobile phone 10 (for example, a phone book and a schedule), a control bottom set 15 for inputting related control instructions to the mobile phone 10. In order to achieve the functionality of wireless communication, the mobile phone 10 further comprises a wireless communication module 16, which comprises a base-band (BB) circuit 18, a RF circuit 20, and an antenna 22. The BB circuit 18 can encode an electrical communication signal outputted by the processing module 12 into a proper base-band signal and transfer the base-band signal to the RF circuit 20. Then, the RF circuit 20 modulates the BF signal and transfers the modulated signal through the antenna 22 in a radio manner. On the other hand, the RF circuit 20 can receive the RF signal, and demodulate the received signal into a BF signal. Then, the BB circuit 18 decodes the BF signal into a communication signal, and transfers the communication signal to the processing module 12 so that the above-mentioned wireless communication function is achieved.

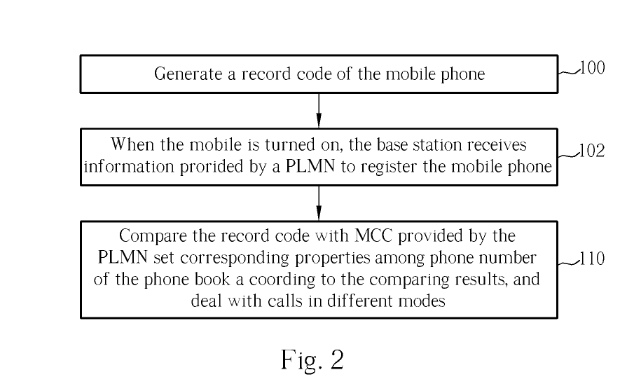

Please refer to FIG. 2, which is a flowchart of a method of managing a phone book of the mobile phone 10 according to an MCC. The method comprises the following steps:

Step 100: Generate a record code of the mobile phone 10, wherein the record code can be an MCC, and the record code can be stored in a SIM card and set by the telecom service provider;

Step 102: When the mobile phone 10 is turned on, the base station 8 receives information provided by a public land mobile network (PLMN) to register the mobile phone 10, wherein the information comprises an area code (for example, the MCC of the mobile phone's position and MNC); and

Step 110: Compare the record code with the MCC provided by the PLMN, set the corresponding properties among phone numbers of the phone book of the mobile phone 10 according to the comparison results, and process a call in different modes.

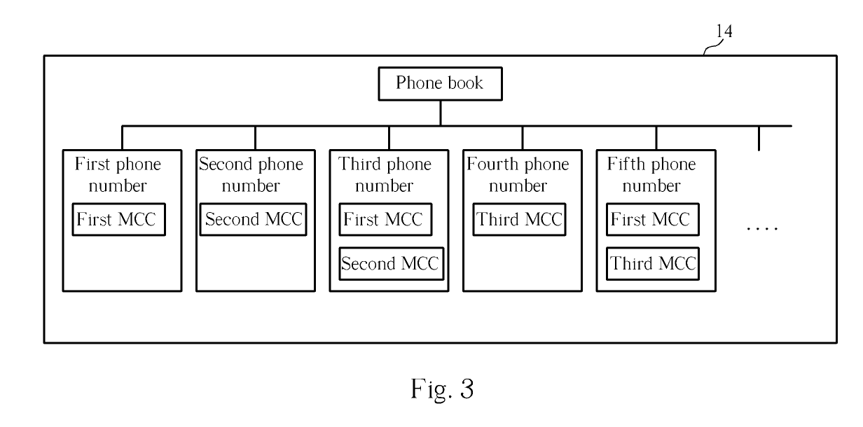

The detailed illustration of the above steps is disclosed as follows. First, users can utilize the control bottom set 15 to set corresponding record codes (such as MCC) of each phone number in the phone book of the mobile phone 10. Please refer to FIG. 3, which is a diagram of each phone number and corresponding MCC stored in the memory module of the mobile phone 10. Users can set all corresponding MCCs of all phone numbers stored in the phone book of the memory module 14. As shown in FIG. 3, the first phone number of the phone book is set to be corresponding to the first MCC, the second phone number is set to be corresponding to the second MCC, the third phone number is set to be corresponding to the first MCC and the second MCC, the fourth is set to be corresponding to the third MCC, and the fifth phone number is ser to be corresponding to the first MCC and the third MCC. Furthermore, the first to fifth phone numbers can each be a normal land-line phone number or a mobile phone number, and these numbers can each be specific whole phone numbers or can utilize a global character “*” to represent a phone number or all phone numbers of a certain country. Here, the MCC can be set to be different according to different countries. For example, the MCC of Taiwan is 466, the MCC of China is 460, and the MCC of Germany is 262.

Generally speaking, the telecom system service end of the mobile phone 10 broadcasts control system information (SI) through broadcast control channel (BCCH) of the base station. Please note that the system information comprises the above-mentioned information provided by the PLMN. Furthermore, the information comprises the MCC of the position of the mobile phone 10 and the MNC information. Therefore, when the mobile phone 10 is turned on, the wireless communication module 16 of the mobile phone 10 receives the aforementioned information, and registers the mobile phone 10 according to the priority defined by the European Telecommunications Standards Institute (ETSI). When the mobile phone 10 is registered successfully, users can know to which PLMN the mobile phone is registered and also know the corresponding MCC according to the message provided by the PLMN.

Then the processing module 12 of the mobile phone 10 compares all corresponding MCCs (for example, the MCCs shown in FIG. 3) with the above-mentioned MCC provided by the PLMN. Furthermore, the processing module 12 sets related properties among the stored phone numbers of the memory module 14, and utilizes a corresponding mode to process the call of the phone number. For example, when the MCC, to which the mobile phone 10 is registered, complies with the first MCC shown in FIG. 3, because the first phone number, third phone number, and the fifth phone number all have a record code corresponding to the first MCC, the processing module 12 sets the related properties among the first phone number, the third phone number, and the fifth phone number according to a corresponding mode. In addition, because the second phone number and the fourth phone number do not have the record code corresponding to the first MCC, the processing module 12 sets the related properties between the second phone number and the fourth phone number according to another corresponding mode. Here, the corresponding mode can be a phone number display or a calling limitation.

Furthermore, for the phone number display setting, users can set the desired phone book according to the phone numbers of different countries. This means that users can set that if the MCC, to which the mobile phone 10 is registered, is the same as that of some phone numbers, the mobile phone 10 can only display those phone numbers. Therefore, following the above-mentioned example, only the first phone number, the third phone number, and the fifth phone number can be shown, but the second phone number and the fourth phone number can not. Oppositely, users can set that if the MCC, to which the mobile phone 10 is registered, is the same as that of some phone numbers, the mobile phone 10 displays other phone numbers instead of those phone numbers. Therefore, a user can manage the phone book according their demands so that the mobile phone can display different contents of the phone book in different countries.

In addition, for the calling limitation setting, users can set a phone number set for different countries according their demands. That is, if a user does not want to answer a certain call from a specific country, the user can establish a phone number set, which comprises phone numbers of the specific country. For example, if the MCC, to which the mobile phone 10 is registered, is equal to the MCC of a certain phone number, the mobile phone 10 does not establish the connection of the call from the certain phone number. Therefore, if the first phone number, the third phone number, and the fifth phone number are refused in a country of the first MCC, and the second phone number and the fourth phone number are acceptable in the country of the first MCC, the user can only receive calls from the second phone number and the fourth phone number. Therefore, the mobile phone 10 automatically filters out the first phone number, the third phone number, the fifth phone number. In other words, when a call of a sixth phone number comes and when the first MCC of the mobile phone 10 is equal to the first MCC of the first phone number, the third phone number, and the fifth phone number, if the sixth phone number is equal to one of the first phone number, the third phone number, and the fifth phone number, the processing module 12 refuses the call of the sixth phone number. On the other hand, if the first MCC of the mobile phone 10 is not equal to the MCC of the second phone number and the fourth phone number and if the sixth phone number is equal to one of the second phone number and the fourth phone number, the processing module 12 directly accepts the call of the sixth phone number. Oppositely, the user can also set that if the MCC of the mobile phone 10 is equal to the MCC of the phone numbers, the phone numbers are not limited. Therefore, when the first MCC of the mobile phone 10 is equal to the first MCC of the first phone number, the third phone number, and the fifth phone number, and if the sixth phone number is equal to the first phone number, the third phone number, and the fifth phone number, the processing module 12 can directly accept the call from the sixth phone number. When the first MCC of mobile phone 10 is not equal to the second phone number and the fourth phone number, and if the sixth phone number is equal to one of the second phone number and the fourth phone number, the processing module 12 refuses the call of the sixth phone number.

Therefore, the user can manage their own phone book in different countries according to their demands. As mentioned above, the users can limit unwanted calls. For example, the users can establish a Taiwan calling limitation phone book, a China calling limitation phone book, and a U.S. calling limitation phone book. Furthermore, the user can utilize the global character “*” to set limited calls of a certain group or from a certain country. For example, if the user is in U.S., the user can set that only local numbers (U.S. origin) be allowed.

Additionally, the mobile phone 10 can be designed to set the properties of all phone numbers or modes of dealing with all calls according comparing results, which are generated through comparing the record codes stored in the memory module 14 with the MCC of the mobile phone 10, instead of setting each record code in the phone book of the mobile phone 10 one by one. For example, if the MCC of the mobile 10 is equal to the record code, the mobile phone 10 processes a call in a first mode, and if the MCC of the mobile phone 10 is not equal to the record code, the mobile phone 10 processes a call in a second mode. The first mode can be set as absolutely accepting the call. For example, when the user sets the record code as the MCC of Taiwan, and if the mobile phone 10 is in Taiwan, all calls are accepted. But if the mobile phone is in U.S., the mobile phone 10 processes all calls in the second mode. Here, the second mode can be set such that the mobile phone 10 accepts a call when the area code (such as the MCC) of the call complies with the area code (such as the MCC of U.S.) and the mobile phone 10 refuses a call when the area code (such as the MCC) of the call does not comply with the area code (such as the MCC of U.S.). Therefore, the cost of roaming is saved and unwanted calls are filtered out.

Furthermore, in the above embodiment, if the user sets a phone number in the calling limitation, when a call from the phone number comes, the mobile phone 10 refuses the call. When the mobile phone 10 refuses a call, the processing module 12 of the mobile phone 10 can send a message to the phone number through the wireless communication module 16 to inform the user of the phone number.

In contrast to the prior art, the present invention method can utilize the MCC, to which the mobile phone is registered, to determine different phone book settings (for example, the phone number display setting or the calling limitation). One of the advantages of the present invention is to provide users with convenience. Another advantage of the present invention is to filter out unneeded calls so that roaming charges are saved. In other words, the present invention provides a good service to travelers such as international sales representatives, who need to go aboard many times, and furthermore, increases the convenience of the mobile phone.

Those skilled in the art will readily observe that numerous modifications and alterations of the device and method may be made while retaining the teachings of the invention. Accordingly, the above disclosure should be construed as limited only by the metes and bounds of the appended claims.

1. A method for managing a mobile phone, the mobile phone comprising a record code, the method comprising:
receiving an area code;
comparing the area code and the record code; and
if the area code is the same as the record code, the mobile phone processing calls in a first mode; and if the area code is different from the record code, the mobile phone processing calls in a second mode.

2. The method of claim 1, wherein the first mode is to absolutely accept the connection of the call.

3. The method of claim 1, wherein the call comprises a call area code; and when the mobile phone is in the second mode, if the call area code is equal to the area code, the mobile phone accepts the connection of the call, and if the call area code is not equal to the area code, the mobile refuses the connection of the call.

4. The method of claim 1, wherein when the mobile phone is in the second mode, the mobile phone stores a first phone number and a second phone number, and the call comprises a third phone number; if the third phone number is equal to the first phone number, the mobile phone accepts the connection of the call in the second mode, and if the third phone number is equal to the second phone number, the mobile phone directly accepts the connection of the call.

5. The method of claim 1, wherein when the mobile phone is in the second mode, the mobile phone stores a first phone number and a second phone number, and the call comprises a third phone number; if the third phone number is equal to the first phone number, the mobile phone refuses the connection of the call in the second mode, and if the third phone number is equal to the second phone number, the mobile phone directly accepts the connection of the call.

6. The method of claim 1, wherein when the mobile phone refuses the connection of the call in the second mode, the mobile phone sends a message to a phone number of the call in order to respond that the connection of the call is not established.

7. The method of claim 1, wherein the mobile phone stores a first phone number, and when the mobile phone is in the first mode, a phone book of the mobile phone displays the first phone number, and when the mobile phone is in the second mode, the phone book of the mobile phone does not display the first phone number.

8. The method of claim 1, wherein the mobile phone stores a first phone number, and when the mobile phone is in the first mode, a phone book of the mobile phone does not display the first phone number, and when the phone number is in the second mode, the phone book of the mobile phone displays the first number.

9. The method of claim 1, wherein the area code is a mobile country code (MCC) provided by a public land mobile network (PLMN).

10. The method of claim 9, wherein the record code is an MCC.

11. A mobile phone for communicating with a base station, the base station broadcasting an area code according to a location of the base station, the mobile phone storing a record code, the mobile phone comprising:
a wireless communication module for receiving the area code;
a memory module for storing the record code; and
a processing module for controlling the mobile phone to process a call in a first mode when the area code is the same as the record code, and for controlling the mobile phone to process the call in a second mode when the area code is not the same as the record code.

12. The mobile phone of claim 11, wherein the processing module controls the mobile phone to absolutely accept the connection of the call in the first mode.

13. The mobile phone of claim 11, wherein the call comprises a call area code; and the processing module controls the mobile phone to accept the connection of the call if the call area code is equal to the area code, and to refuse the connection of the call if the call area code is not equal the area code, in the second mode.

14. The mobile phone of claim 11, wherein when the mobile phone is in the second mode, the mobile phone stores a first phone number and a second phone number, and the call comprises a third phone number; if the third phone number is equal to the first phone number, the processing module controls the mobile phone to accept the connection of the call in the second mode, and if the third phone number is equal to the second phone number, the processing module controls the mobile phone to directly accept the connection of the call.

15. The mobile phone of claim 11, wherein when the mobile phone is in the second mode, the mobile phone stores a first phone number and a second phone number, and the call comprises a third phone number; if the third phone number is equal to the first phone number, the processing module controls the mobile phone to refuse the connection of the call, and if the third phone number is equal to the second phone number, the processing module controls the mobile phone to directly accept the connection of the call.

16. The mobile phone of claim 11, wherein when the mobile phone refuses the connection of the call in the second mode, the processing module controls the mobile phone to send a message to a phone number of the call in order to respond that the connection of the call is not established.

17. The mobile phone of claim 17, wherein the mobile phone stores a first phone number, and when the mobile phone is in the first mode, the processing module controls a phone book of the mobile phone to display the first phone number, and when the mobile phone is in the second mode, the processing module controls the phone book of the mobile phone not to display the first phone number.

18. The mobile phone of claim 11, wherein the mobile phone stores a first phone number, and when the mobile phone is in the first mode, the processing module controls a phone book of the mobile phone not to display the first phone number, and when the mobile phone is in the second mode, the processing module controls the phone book to display the first phone number.

19. The mobile phone of claim 11, wherein the area code is a mobile country code (MCC) provided by a public land mobile network (PLMN).

20. The mobile phone of claim 19, wherein the record code is an MCC.
